(19) United States
(12) Patent Application Publication
(10) Pub. No.: US 2025/0030467 A1
(43) Pub. Date: Jan. 23, 2025

(54) TWO-PORT DYNAMIC BEAMS

(71) Applicant: QUALCOMM Incorporated, San Diego, CA (US)

(72) Inventors: Kang GAO, San Diego, CA (US); Yongle WU, San Diego, CA (US); Jun ZHU, San Diego, CA (US); Vasanthan RAGHAVAN, West Windsor Township, NJ (US); Derrick Albert CHU, San Diego, CA (US); Raghu Narayan CHALLA, San Diego, CA (US)

(21) Appl. No.: 18/353,836

(22) Filed: Jul. 17, 2023

(51) Int. Cl. H04B 7/06; H04L 5/00; H04W 24/08

(52) U.S. Cl. CPC H04B 7/0617; H04B 7/0626; H04L 5/0051; H04W 24/08

(57) ABSTRACT

Aspects of the disclosure are directed to generation of N-port dynamic beams. For example, a user equipment (UE) may be using a 2-port predefined receive beam for communication with a wireless node. The UE may estimate a channel using the predefined receive beam to measure a rank2 reference signal received from the wireless node. The UE may generate a dynamic beam weight to maximize a communication parameter based on the estimated channel. The UE may then apply the dynamic beam weight to an antenna array.

### BACKGROUND

### Technical Field

The present disclosure generally relates to communication systems, and more particularly, techniques for wireless communication via two-port dynamic beams.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of wireless communication at a user equipment (UE). In some examples, the method includes estimating a channel using one or more predefined receive beams to measure a rank2 reference signal received from a wireless node. In some examples, the method includes generating a dynamic beam weight to maximize a communication parameter based on the estimated channel. In some examples, the method includes applying the dynamic beam weight to an antenna array.

In some aspects, the techniques described herein relate to an apparatus for wireless communication, including: one or more memories, individually or in combination, having instructions; and one or more processors, individually or in combination, configured to execute the instructions and cause the apparatus to: estimate a channel using one or more predefined receive beams to measure a rank2 reference signal received from a wireless node; generate a dynamic beam weight to maximize a communication parameter based on the estimated channel; and apply the dynamic beam weight to an antenna array.

In some aspects, the techniques described herein relate to an apparatus for wireless communication, including: means for estimating a channel using one or more predefined receive beams to measure a rank2 reference signal received from a wireless node; means for generating a dynamic beam weight to maximize a communication parameter based on the estimated channel; and means for applying the dynamic beam weight to an antenna array.

In some aspects, the techniques described herein relate to a non-transitory, computer-readable medium including computer executable code, the code when executed by one or more processors causes the one or more processors to, individually or in combination: estimate a channel using one or more predefined receive beams to measure a rank2 reference signal received from a wireless node; generate a dynamic beam weight to maximize a communication parameter based on the estimated channel; and apply the dynamic beam weight to an antenna array.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 a conceptual diagram illustrating beams transmitted from a base station to a UE.

FIG. 6 is a diagram illustrating an example spatial correlation matrix for an antenna array.

FIG. 7 is a flow diagram conceptually illustrating techniques for generating two-port dynamic beams.

FIG. 8 is a flowchart of a method of wireless communication.

FIG. 9 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a conventional user equipment (UE), the UE may be indicated with or select a beam from a codebook of static beams for transmission or reception. Legacy static beams are designed for a free space environment for an in-coverage region to achieve high reference signal received power (RSRP), but static beams may not be optimal when the electric field is changed due to hand blockage, non-line-of-sight channel, or other materials like metal table or UE housing. Even in a free space out of coverage region, static beams may not be ideal. That is, when a UE is limited to a set of pre-defined static beams in a codebook, there may exist better beam weights for a particular environment. Beam selection or training based on a codebook may also include overhead for additional reference signals on different beams and/or indications of preferred beams. Moreover, legacy beam management procedures performed between wireless devices typically use synchronization signal blocks (SSBs) which, although being effective for rank 1 communications, may not improve rank 2 performance.

Thus, aspects of the specification are directed to using rank 2 reference signals (e.g., channel state information reference signal (CSI-RS)) to determine rank 2 channel information and dynamic beam parameters such as beam weight and/or phase shift. Dynamic beams refer to techniques that allow adaptive changes to weights used for beamforming based on changes in the channel environment to achieve better signal quality (e.g., RSRP). In order to generate dynamic beams, the channel information is required. The channel information can be described by a spatial correlation matrix (e.g., channel correlation matrix), R.

In certain aspects, the spatial correlation matrix may be obtained through some measurement using pre-determined (e.g., codebook) receiving beams. One technique to obtain the R matrix for an N-element subarray (e.g., an N×N spatial correlation matrix) uses N2 RSRP measurements. Dynamic beam weights may be generated from the spatial correlation matrix that maximizes a RSRP based on the estimated channel. In some implementations, the set of dynamic beam weights may be generated by quantizing values of the eigenvector of the spatial correlation matrix. The set of dynamic beam weights may be applied to an antenna array. For example, the set of dynamic beam weights may be used to generate a receive beam and/or a transmit beam.

Particular implementations of the subject matter described in this disclosure can be implemented to realize one or more of the following potential advantages. The use of dynamic beam weights may improve reception and/or transmission of RF signals, especially in channel conditions for which pre-defined static beams are not designed such as blockage scenarios and non-line of sight. For example, signal quality (e.g., signal to noise ratio (SNR)) or spectral efficiency may be improved. Additionally, the gains may be applicable when the UE is rotated. In some implementations, the use of channel impulse response measurements to estimate the channel may improve the speed of channel estimation and dynamic beam generation over conventional measurements.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

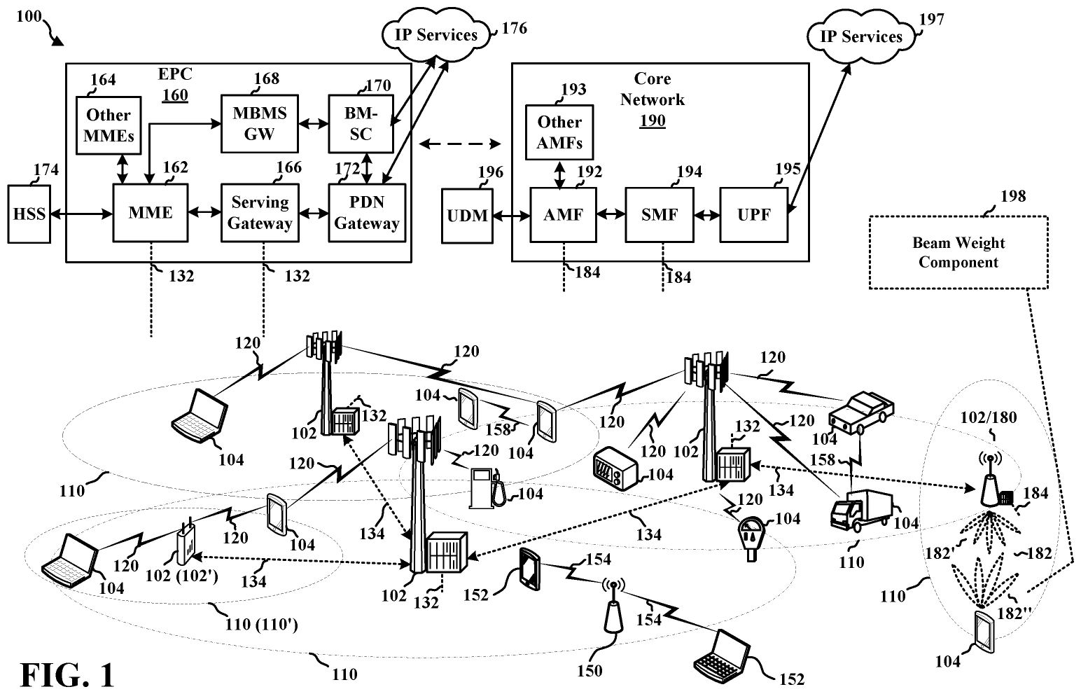

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing. Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154. e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, the UE 104 may include a beam weight component 198. As described in more detail elsewhere herein, the beam weight component 198 may be configured to estimate a channel using one or more predefined receive beams to measure a rank2 reference signal received from a wireless node. The beam weight component 198 may also be configured to generate a dynamic beam weight to maximize a communication parameter based on the estimated channel. The beam weight component 198 may also be configured to apply the dynamic beam weight to an antenna array. Additionally, or alternatively, the beam weight component 198 may perform one or more other operations described herein.

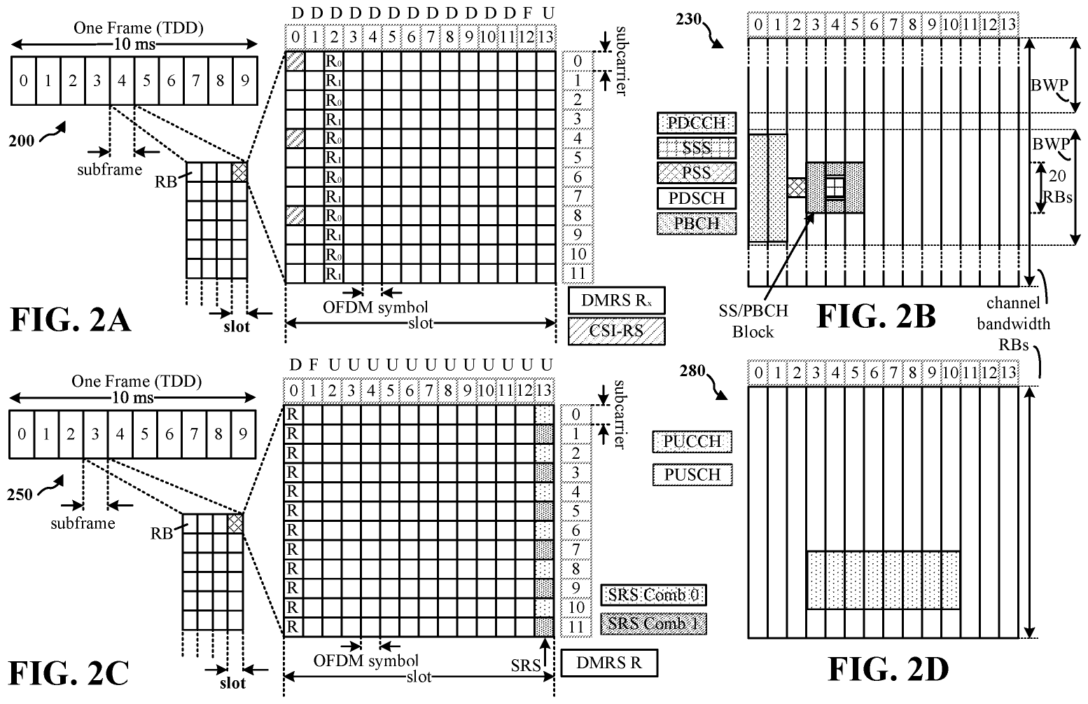

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

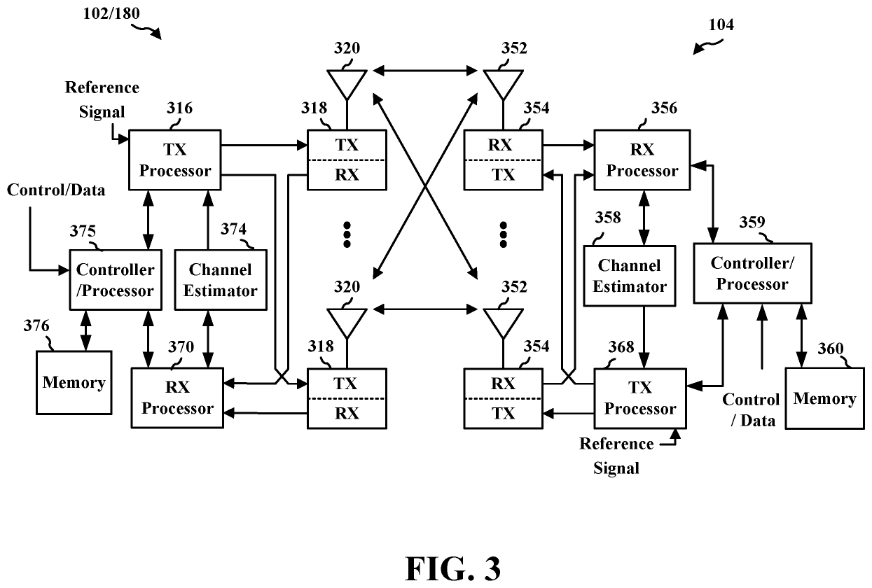

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality. It should be noted that each receiver 354RX, its respective antenna 352, and the receive (RX) processor 356 may form an aspect of a UE radio frequency integrated circuit (RFIC).

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

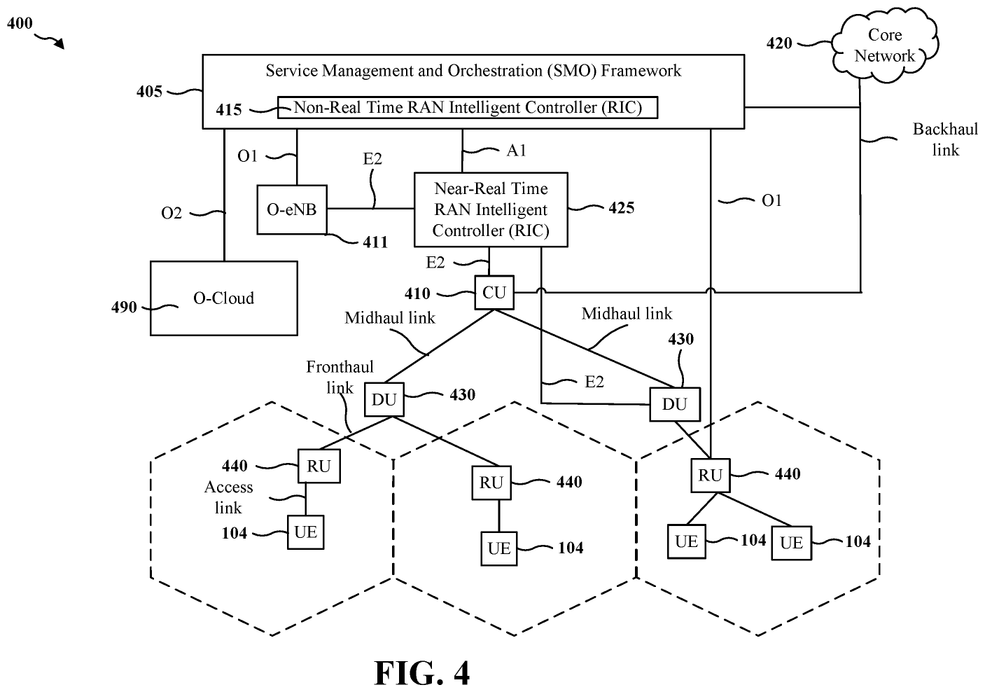

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open cNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

At least one of the TX processor 368, the RX processor 356, and the controller/processor 359 may be configured to perform aspects in connection with the beam weight component 198 of FIG. 1.

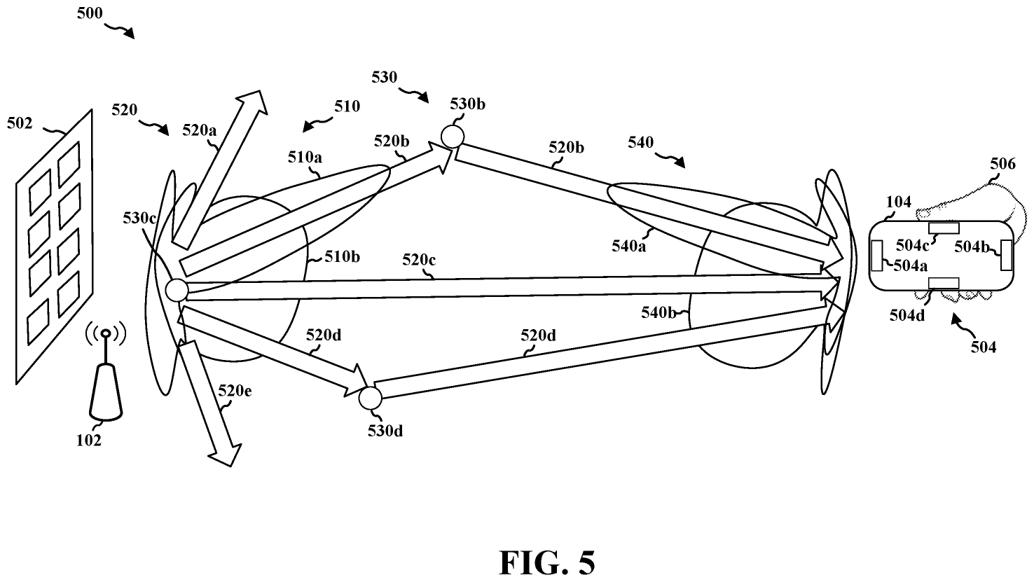

Turning to FIG. 5, a conceptual diagram 500 includes beams 510 transmitted from a base station 102 to a UE 104. The beams 510 may be the result of different antenna configurations at the base station 102, which may typically include a large antenna array 502 for beam steering. For example, the beams 510 may include a first beam 510a that is relatively narrow and a second beam 510b that is relatively wide. The base station 102 may control beam weights to steer the beams 510 in a particular direction. For example, a channel may include multiple paths 520 (e.g., paths 520a-520e) between the base station 102 and the UE 104. For instance, a direct path 520c may exist if there is a line of sight between the base station 102 and the UE 104. An RF signal may also follow an indirect path. For example, the signal may reflect off an object such as a building, vehicle, or window.

From the perspective of the UE 104 including antenna modules 504 (e.g., antenna modules 504a, 504b, 504c, and 504d), the signal may appear to arrive from a certain direction via reflections or diffraction (typically called a cluster 530). A cluster (e.g., clusters 530b-530d) may be a reflected or a diffracted source of a signal that arrives at the UE 104. For example, a cluster 530c may correspond to the base station 102 and the clusters 530b and 530d may correspond to objects that reflect the signals in the indirect paths 520b and 520d, respectively. Other paths such as path 520a and 520e may not reach the UE 104 with sufficient signal strength. The UE 104 may have an active antenna configuration that generates a receive beam 540 (e.g., receive beams 540a and 540b). For example, the receive beam 540a may be generated by a first active antenna configuration and the receive beam 540b may be generated by a second active antenna configuration. The UE 104 may control antenna weights to steer the receive beam 540 towards one or more clusters 530. A strongest cluster may be referred to as a dominant cluster and other clusters may be referred to as sub-dominant clusters.

In some scenarios, the position of a hand 506 on the UE 104 may cause hand blockage that affects the receive beams 540. The deterioration may be approximately 0-40 dB depending on the angle of the cluster relative to the orientation and properties of the hand. Structures in the fingers of the hand can irregularly reflect energy. Such reflections may be mitigated with appropriate phase shifter and amplitude control adaptations. In some cases, beam switching may improve reception if beam switching latencies are small relative to timescales at which data disruption are acceptable or at timescales at which channel/cluster properties changes. These timescales depend on UE mobility and use-cases. Further, legacy beam switching using codebooks and beam training may come at an overhead on a control channel, which may not be acceptable in some cases. In an aspect, sensing based dynamic beams may allow the UE 104 to dynamically change to beams that are suitable for channel conditions, even if a codebook does not include beams designed for the channel conditions.

As noted, a channel may include multiple paths 520 (e.g., paths 520a-520e) between the base station 102 and the UE 104. In a MIMO example, the base station 102 and the UE 104 may communicate via multiple channels and/or subchannels within a given channel. The number of channels/subchannels used for such communication is often referred to as a “transmission rank” (e.g., rank 1, rank 2, etc.). In some examples, the transmission rank may be or otherwise correspond to a number of layers or streams (e.g., MIMO layers/streams) on which the UE 104 may simultaneously transmit and/or receive information.

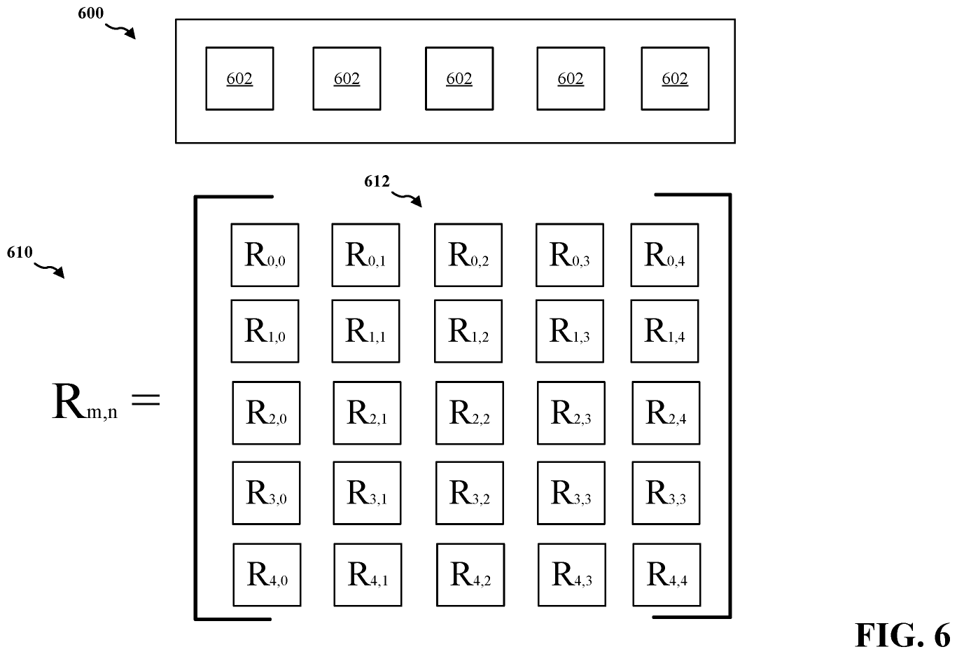

FIG. 6 is a diagram illustrating an example spatial correlation matrix 610 for an antenna array 600. The antenna array 600 may include any suitable number of antenna elements, N. In the illustrated example, N is 6. In order to generate dynamic beams, channel information is required. The channel information may be represented as the spatial correlation matrix 610. The spatial correlation matrix 610 may be an N×N matrix, and may be referred to as R. Each element 612 in the spatial correlation matrix 610 may be an RSRP or an SINR corresponding to a receiving beam. A receiving beam may be a defined beam with a known weight. Each channel measurement may correspond to a different receiving beam. The channel measurements may be performed on a reference signal such as a CSI-RS or any other suitable rank 2 reference signal. One method to obtain the R matrix for an N-element subarray uses N² RSRP measurements. For example, the RSRP measurements may be performed on reference signals using each receiving beam.

In certain aspects, the R matrix may be obtained using a channel impulse response (CIR) based method that can measure the CIR on each antenna element 602. A CIR based method can greatly speed-up the N×N spatial correlation matrix computation by using only about N measurements with \hat{R}ₘₙ=hₘ^{H}hₙ. Here, \hat{R}ₘₙ is the estimate of m-th row and n-th column of R matrix, and hₙ is the CIR measured at the n-th elements. If the CIR is measured on three beams on each reference signal, only 2 reference signals may be needed to determine the R matrix.

Because the RSRP of a beam with weight w can be estimated by using RSRPₑₛₜ(w)=w^{H}\hat{R}w, the beam weight component 198 can generate a dynamic beam by using the eigenvector of the R matrix to maximize the RSRP. To satisfy the phase and magnitude constraint, the beam weight component 198 can further apply proper quantization of the phase and magnitude. The beam weight component 198 can therefore obtain the dynamic beams for both polarizations of the subarray, which are adapted to the channel to obtain higher RSRP than pre-designed static beams.

### Examples of Two-Port Dynamic Beams

Aspects of the disclosure are directed to estimating a channel (e.g., determining a channel impulse response (CIR)) based on a polarization at a network entity (e.g., base station 102/180, RU 440, DU 430, and/or CU 410) and a polarization at a UE (e.g., UE 104), from which a spatial correlation matrix 610 may be computed by the UE 104.

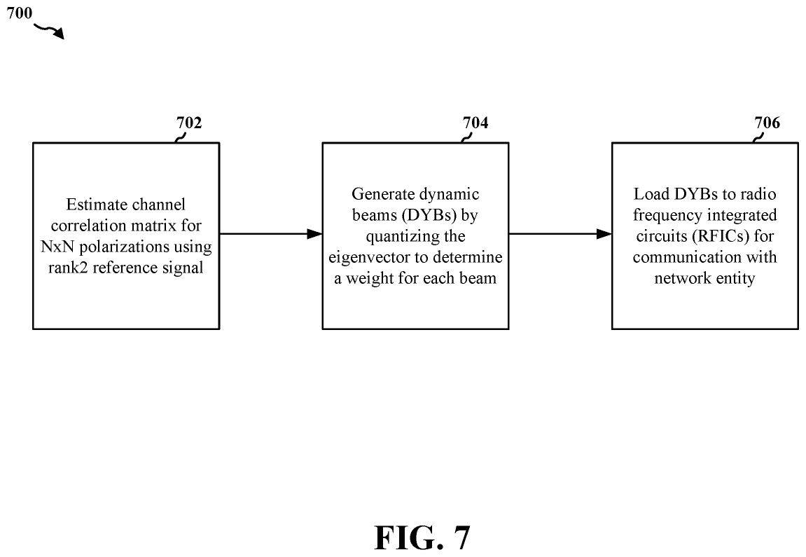

FIG. 7 is a flow diagram conceptually illustrating actions 700 for generating two-port dynamic beams. In a first action 702, the UE 104 may estimate a channel using one or more predefined receive beams to measure a rank2 reference signal received from the network entity 102. For example, the UE 104 may determine polarization at the network entity 102 as “pol 0” and “pol 1,” and determine polarization at the UE as “port H” and “port V.” Accordingly, the channel correlation matric at UE port n and network entity pol k may be computed as R_{n,k}(n∈{port H, port V}, k∈{pol 0, pol 1}).

At a second action 704, the UE 104 may generate a dynamic beam (DYB) weight to maximize a communication parameter based on the estimated channel. For example, DYB weights for each of port H and port V may be computed using equations 1 and 2 below:

$${\sum }_{n ∈ \{ H , V \}} {\sum }_{k ∈ \{ 0 , 1 \}} {w}_{n}^{H} ( {R}_{n , k} ) {w}_{n} = {\sum }_{n ∈ \{ H , V \}} {w}_{n}^{H} ( {R}_{n , 0} + {R}_{n , 1} ) {w}_{n} \qquad Equation l$$

where wₙ^{H} is a weight for port H, R_{n,k} is a scalar for UE port n and network entity pol k. The same equation may be applied for port V. The UE 104 may then quantize the eigenvector of (R_{n,0}+R_{n,1}) for each polarization n∈{H, V} and optimize each port (e.g., port H and port V) independently by determining a weight to be applied at each port:

$${w}_{n} = quan ( eig ( {R}_{n , 0} + {R}_{n , 1} ) ) , n ∈ \{ H , V \} \qquad Equation 2$$

where wₙ is a weight for ports H and/or V, and wherein quan(eig(R_{n,0}+R_{n,1})) is a phase value.

At a third action 706, the UE 104 may apply the DYB weights to an antenna array. For example, the UE 104 may load the DYB weights to radio frequency integrated circuits (RFICs) to adjust direction of a UE 104 codebook receiving and/or transmitting beam to optimize communication with the network entity. For example, the codebook beams may not provide the UE 104 with the best possible signal quality or power. Accordingly, the UE 104 may apply the determined weights to ports H and V, thereby adjusting a direction of a receive and transmit beam to improve communication with the network entity 102.

It should be noted that although the examples above relate to communications between a UE 104 and a network entity 102, the same aspects may apply to sidelink communications between two UEs or between a UE and an AP, edge server, or the like. Thus, UE-side beam optimization may be performed by a UE in communication with any suitable wireless node.

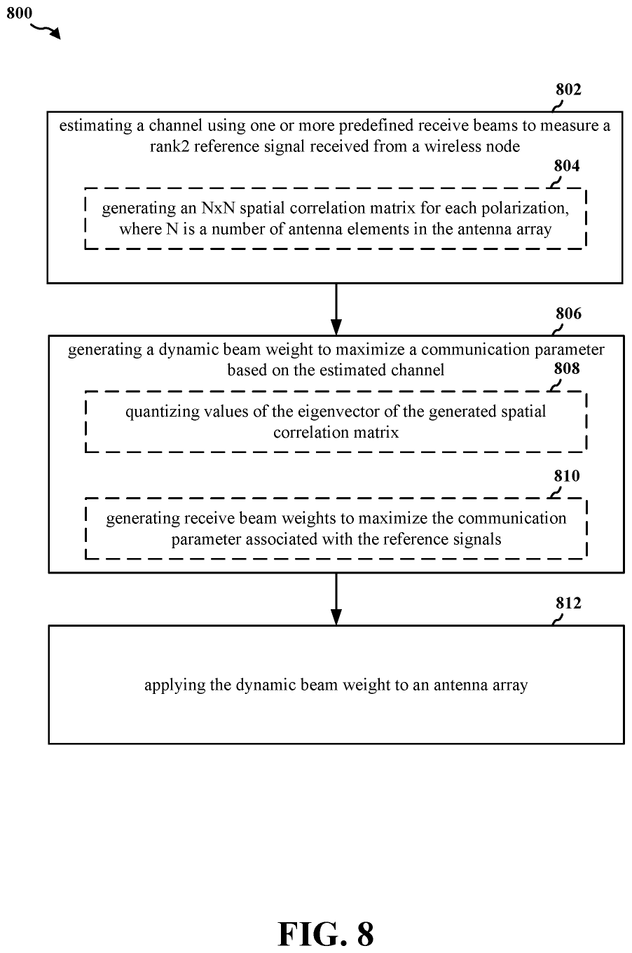

FIG. 8 is a flowchart 800 of a method of wireless communication. The method may be performed by a UE (e.g., the UE 104; the apparatus 902).

At 802, the UE may estimate a channel using one or more predefined receive beams to measure a rank2 reference signal received from a wireless node. For example, 802 may be performed by an estimating component 940.

Optionally, at 804, the UE may generate an N×N spatial correlation matrix for each polarization, where N is a number of antenna elements in the antenna array. In some examples, the spatial correlation matrix is a 2×2 matrix based on two polarizations at the UE (e.g., port H and port V). In some instances, 804 may be performed by a generating component 942.

At 806, the UE may generate a dynamic beam weight to maximize a communication parameter based on the estimated channel. Here, the UE may determine a beam weight (wₙ) for each antenna element (e.g., using the example above, a weight for each of port H and port V) to adjust a direction of a beam associated with each antenna element. In some instances, 806 may be performed by the generating component 942.

Optionally, at 808, the UE may quantize values of the eigenvector of the generated spatial correlation matrix to generate the dynamic beam weight. Here, for example, the UE may use Equation 2 to determine a beam weight. In some instances, 808 may be performed by a quantizing component 944.

Optionally, at 810, the UE may generate receive beam weights to maximize the communication parameter associated with the reference signals. For example, the communication parameter may include one or more of a reference signal received power (RSRP), a signal to interference and noise ratio (SINR), or a channel impulse response (CIR). Thus, the UE may apply the beam weights to a codebook receive beam to dynamically adjust the receive beam and improve reception quality of downlink signaling or sidelink signaling at the UE. In some instances, 810 may be performed by the generating component 942.

At 812, the UE may apply the dynamic beam weight to an antenna array. For example, using the above example of the 2×2 polarization, the UE may apply the dynamic beam weight to a beam associated with each antenna element (port H and port V) at the UE. In some instances, 812 may be performed by an applying component 946.

In certain aspects, the communication parameter includes a reference signal received power (RSRP), a signal to interference and noise ratio (SINR), or a channel impulse response.

In certain aspects, the rank2 reference signal includes a channel state information reference signal (CSI-RS).

In certain aspects, the dynamic beam weight is based on an eigenvector of spatial correlation matrices generated for each polarization.

In certain aspects, the one or more predefined receive beams are used to measure the communication parameter for each antenna element in the spatial correlation matrix. For example, the one or more predefined receive beams may be codebook beams.

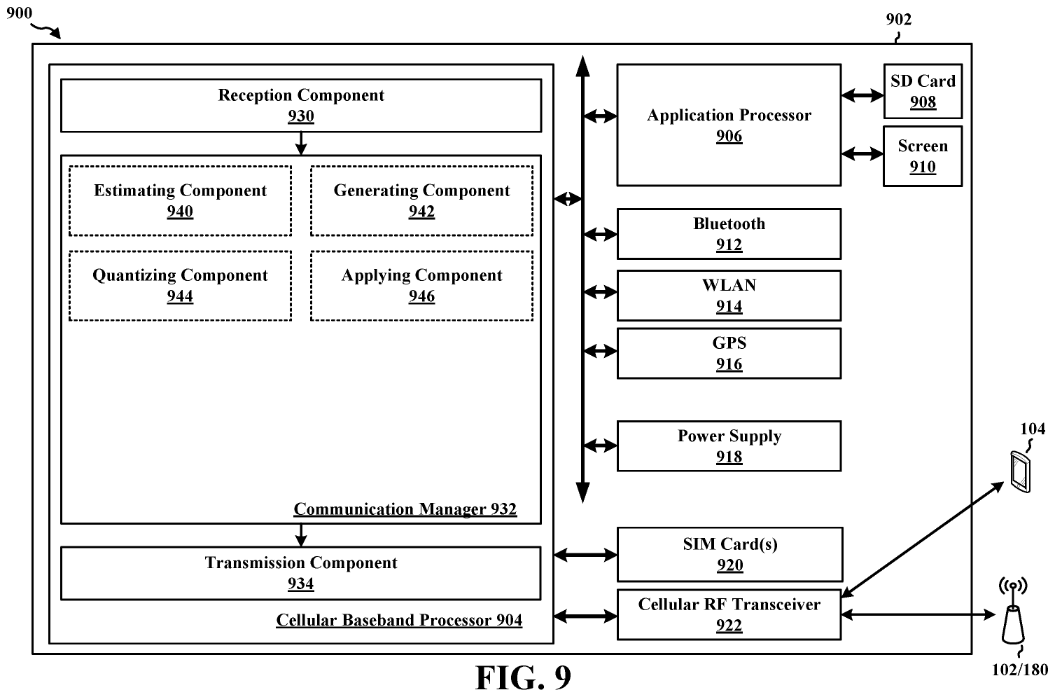

FIG. 9 is a diagram 900 illustrating an example of a hardware implementation for an apparatus 902. The apparatus 902 is a UE and includes a cellular baseband processor 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 104 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see UE 104 of FIG. 3) and include the aforediscussed additional modules of the apparatus 902. In various examples, the apparatus 902 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 932 includes an estimating component 940 that is configured to estimate a channel using one or more predefined receive beams to measure a rank2 reference signal received from a wireless node, e.g., as described in connection with 802 of FIG. 8.

The communication manager 932 further includes a generating component 942 configured to generate an N×N spatial correlation matrix for each polarization, where N is a number of antenna elements in the antenna array; generate a dynamic beam weight to maximize a communication parameter based on the estimated channel; and generate receive beam weights to maximize the communication parameter associated with the reference signals, e.g., as described in connection with 804, 806, and 810 of FIG. 8.

The communication manager 932 further includes a quantizing component 944 configured to quantize values of the eigenvector of the generated spatial correlation matrix, e.g., as described in connection with 80 of FIG. 8.

The communication manager 932 further includes an applying component 946 configured to apply the dynamic beam weight to an antenna array, e.g., as described in connection with 812 of FIG. 8.

The apparatus may include additional components that perform each of the blocks of the algorithm in the aforementioned flowcharts of FIGS. 7 and 8. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes means for estimating a channel using one or more predefined receive beams to measure a rank2 reference signal received from a wireless node; means for generating an N×N spatial correlation matrix for each polarization, where N is a number of antenna elements in the antenna array; means for generating a dynamic beam weight to maximize a communication parameter based on the estimated channel; means for quantizing values of the eigenvector of the generated spatial correlation matrix; means for generating receive beam weights to maximize the communication parameter associated with the reference signals; and means for applying the dynamic beam weight to an antenna array.

The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

### Additional Considerations

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Clause 1. A method of wireless communication at a user equipment (UE), comprising: estimating a channel using one or more predefined receive beams to measure a rank2 reference signal received from a wireless node; generating a dynamic beam weight to maximize a communication parameter based on the estimated channel; and applying the dynamic beam weight to an antenna array.

Clause 2. The method of clause 1, wherein the communication parameter includes a reference signal received power (RSRP), a signal to interference and noise ratio (SINR), or a channel impulse response.

Clause 3. The method of any of clauses 1 and 2, wherein the rank2 reference signal includes a channel state information reference signal (CSI-RS).

Clause 4. The method of any of clauses 1-3, wherein estimating the channel comprises generating an N×N spatial correlation matrix for each polarization, where N is a number of antenna elements in the antenna array.

Clause 5. The method of clause 4, wherein the dynamic beam weight is based on an eigenvector of spatial correlation matrices generated for each polarization.

Clause 6. The method of any of clauses 4 and 5, wherein generating the dynamic beam weight comprises quantizing values of the eigenvector of the spatial correlation matrices generated for each polarization.

Clause 7. The method of any of clauses 4-6, wherein the one or more predefined receive beams are used to measure the communication parameter for each antenna element in the spatial correlation matrix.

Clause 8. The method of any of clauses 1-7, wherein generating the dynamic beam weight comprises generating receive beam weights to maximize the communication parameter associated with the rank2 reference signal.

Clause 9. An apparatus for wireless communication, comprising: one or more memories, individually or in combination, having instructions; and one or more processors, individually or in combination, configured to execute the instructions and cause the apparatus to: estimate a channel using one or more predefined receive beams to measure a rank2 reference signal received from a wireless node; generate a dynamic beam weight to maximize a communication parameter based on the estimated channel; and apply the dynamic beam weight to an antenna array.

Clause 10. The apparatus of clause 9, wherein the communication parameter includes a reference signal received power (RSRP), a signal to interference and noise ratio (SINR), or a channel impulse response.

Clause 11. The apparatus of any of clauses 9 and 10, wherein the rank2 reference signal includes a channel state information reference signal (CSI-RS).

Clause 12. The apparatus of any of clauses 9-11, wherein estimating the channel comprises generating an N×N spatial correlation matrix for each polarization, where N is a number of antenna elements in the antenna array.

Clause 13. The apparatus of clause 12, wherein the dynamic beam weight is based on an eigenvector of spatial correlation matrices generated for each polarization.

Clause 14. The apparatus of any of clauses 12 and 13, wherein generating the dynamic beam weight comprises quantizing values of the eigenvector of the spatial correlation matrices generated for each polarization.

Clause 15. The apparatus of any of clauses 12-14, wherein the one or more predefined receive beams are used to measure the communication parameter for each antenna element in the spatial correlation matrix.

Clause 16. The apparatus of any of clauses 9-15, wherein the one or more processors, individually or in combination, are further configured to cause the apparatus to generate receive beam weights to maximize the communication parameter associated with the rank2 reference signal.

Clause 17. An apparatus for wireless communication, comprising: means for estimating a channel using one or more predefined receive beams to measure a rank2 reference signal received from a wireless node; means for generating a dynamic beam weight to maximize a communication parameter based on the estimated channel; and means for applying the dynamic beam weight to an antenna array.

Clause 18. The apparatus of clause 17, wherein: means for estimating a channel comprises a radio frequency integrated circuit (RFIC) and one or more processors; means for generating a dynamic beam weight comprises one or more processors; and means for applying the dynamic beam weight comprises the RFIC and one or more processors.

Clause 19. The apparatus of any of clauses 17 and 18, wherein the communication parameter includes a reference signal received power (RSRP), a signal to interference and noise ratio (SINR), or a channel impulse response.

Clause 20. The apparatus of any of clauses 17-19, wherein the rank2 reference signal includes a channel state information reference signal (CSI-RS).

Clause 21. The apparatus of any of clauses 17-20, wherein the means for estimating the channel comprises means for generating an N×N spatial correlation matrix for each polarization, where N is a number of antenna elements in the antenna array.

Clause 22. The apparatus of clause 21, wherein the dynamic beam weight is based on an eigenvector of spatial correlation matrices generated for each polarization.

Clause 23. The apparatus of any of clauses 21 and 22, wherein means for generating the dynamic beam weight comprises means for quantizing values of the eigenvector of the spatial correlation matrices generated for each polarization.

Clause 24. The apparatus of any of clauses 21-23, wherein the one or more predefined receive beams are used to measure the communication parameter for each antenna element in the spatial correlation matrix.

Clause 25. The apparatus of any of clauses 17-24, wherein the means for generating the dynamic beam weight comprises means for generating receive beam weights to maximize the communication parameter associated with the rank2 reference signal.

Clause 26. A non-transitory, computer-readable medium comprising computer executable code, the code when executed by one or more processors causes the one or more processors to, individually or in combination: estimate a channel using one or more predefined receive beams to measure a rank2 reference signal received from a wireless node; generate a dynamic beam weight to maximize a communication parameter based on the estimated channel; and apply the dynamic beam weight to an antenna array.

Clause 27. The non-transitory, computer-readable medium of clause 26, wherein the communication parameter includes a reference signal received power (RSRP), a signal to interference and noise ratio (SINR), or a channel impulse response.

Clause 28. The non-transitory, computer-readable medium of any of clauses 26 and 27, wherein the rank2 reference signal includes a channel state information reference signal (CSI-RS).

Clause 29. The non-transitory, computer-readable medium of any of clauses 26-28, wherein the code when executed by the one or more processors further causes the one or more processors to, individually or in combination, generate an N×N spatial correlation matrix for each polarization, where N is a number of antenna elements in the antenna array.

Clause 30. The non-transitory, computer-readable medium of clause 29, wherein the dynamic beam weight is based on an eigenvector of spatial correlation matrices generated for each polarization.

What is claimed is:

1. A method of wireless communication at a user equipment (UE), comprising:
estimating a channel using one or more predefined receive beams to measure a rank2 reference signal received from a wireless node;
generating a dynamic beam weight to maximize a communication parameter based on the estimated channel; and
applying the dynamic beam weight to an antenna array.

2. The method of claim 1, wherein the communication parameter includes a reference signal received power (RSRP), a signal to interference and noise ratio (SINR), or a channel impulse response.

3. The method of claim 1, wherein the rank2 reference signal includes a channel state information reference signal (CSI-RS).

4. The method of claim 1, wherein estimating the channel comprises generating an N×N spatial correlation matrix for each polarization, where N is a number of antenna elements in the antenna array.

5. The method of claim 4, wherein the dynamic beam weight is based on an eigenvector of spatial correlation matrices generated for each polarization.

6. The method of claim 5, wherein generating the dynamic beam weight comprises quantizing values of the eigenvector of the spatial correlation matrices generated for each polarization.

7. The method of claim 4, wherein the one or more predefined receive beams are used to measure the communication parameter for each antenna element in the spatial correlation matrix.

8. The method of claim 1, wherein generating the dynamic beam weight comprises generating receive beam weights to maximize the communication parameter associated with the rank2 reference signal.

9. An apparatus for wireless communication, comprising:
one or more memories, individually or in combination, having instructions; and
one or more processors, individually or in combination, configured to execute the instructions and cause the apparatus to:
estimate a channel using one or more predefined receive beams to measure a rank2 reference signal received from a wireless node;
generate a dynamic beam weight to maximize a communication parameter based on the estimated channel; and
apply the dynamic beam weight to an antenna array.

10. The apparatus of claim 9, wherein the communication parameter includes a reference signal received power (RSRP), a signal to interference and noise ratio (SINR), or a channel impulse response.

11. The apparatus of claim 9, wherein the rank2 reference signal includes a channel state information reference signal (CSI-RS).

12. The apparatus of claim 9, wherein estimating the channel comprises generating an N×N spatial correlation matrix for each polarization, where N is a number of antenna elements in the antenna array.

13. The apparatus of claim 12, wherein the dynamic beam weight is based on an eigenvector of spatial correlation matrices generated for each polarization.

14. The apparatus of claim 13, wherein generating the dynamic beam weight comprises quantizing values of the eigenvector of the spatial correlation matrices generated for each polarization.

15. The apparatus of claim 12, wherein the one or more predefined receive beams are used to measure the communication parameter for each antenna element in the spatial correlation matrix.

16. The apparatus of claim 9, wherein the one or more processors, individually or in combination, are further configured to cause the apparatus to generate receive beam weights to maximize the communication parameter associated with the rank2 reference signal.

17. An apparatus for wireless communication, comprising:
means for estimating a channel using one or more predefined receive beams to measure a rank2 reference signal received from a wireless node;
means for generating a dynamic beam weight to maximize a communication parameter based on the estimated channel; and
means for applying the dynamic beam weight to an antenna array.

18. The apparatus of claim 17, wherein:
means for estimating a channel comprises a radio frequency integrated circuit (RFIC) and one or more processors;
means for generating a dynamic beam weight comprises one or more processors; and
means for applying the dynamic beam weight comprises the RFIC and one or more processors.

19. The apparatus of claim 17, wherein the communication parameter includes a reference signal received power (RSRP), a signal to interference and noise ratio (SINR), or a channel impulse response.

20. The apparatus of claim 17, wherein the rank2 reference signal includes a channel state information reference signal (CSI-RS).

21. The apparatus of claim 17, wherein the means for estimating the channel comprises means for generating an N×N spatial correlation matrix for each polarization, where N is a number of antenna elements in the antenna array.

22. The apparatus of claim 21, wherein the dynamic beam weight is based on an eigenvector of spatial correlation matrices generated for each polarization.

23. The apparatus of claim 22, wherein means for generating the dynamic beam weight comprises means for quantizing values of the eigenvector of the spatial correlation matrices generated for each polarization.

24. The apparatus of claim 21, wherein the one or more predefined receive beams are used to measure the communication parameter for each antenna element in the spatial correlation matrix.

25. The apparatus of claim 17, wherein the means for generating the dynamic beam weight comprises means for generating receive beam weights to maximize the communication parameter associated with the rank2 reference signal.

26. A non-transitory, computer-readable medium comprising computer executable code, the code when executed by one or more processors causes the one or more processors to, individually or in combination:
estimate a channel using one or more predefined receive beams to measure a rank2 reference signal received from a wireless node;
generate a dynamic beam weight to maximize a communication parameter based on the estimated channel; and
apply the dynamic beam weight to an antenna array.

27. The non-transitory, computer-readable medium of claim 26, wherein the communication parameter includes a reference signal received power (RSRP), a signal to interference and noise ratio (SINR), or a channel impulse response.

28. The non-transitory, computer-readable medium of claim 26, wherein the rank2 reference signal includes a channel state information reference signal (CSI-RS).

29. The non-transitory, computer-readable medium of claim 26, wherein the code when executed by the one or more processors further causes the one or more processors to, individually or in combination, generate an N×N spatial correlation matrix for each polarization, where N is a number of antenna elements in the antenna array.

30. The non-transitory, computer-readable medium of claim 29, wherein the dynamic beam weight is based on an eigenvector of spatial correlation matrices generated for each polarization.
